(19) United States
(12) Patent Application Publication
(10) Pub. No.: US 2018/0246026 A1
(43) Pub. Date: Aug. 30, 2018

(54) SYSTEMS, METHODS, AND DEVICES FOR UTILIZING A DUST SENSOR INDICATOR

(71) Applicants: Kevin CAI, Morristown, NJ (US); Honeywell International Inc., Morris Plains, NJ (US)

(72) Inventor: Kevin Cai, Shanghai (CN)

(21) Appl. No.: 15/755,452

(22) PCT Filed: Aug. 25, 2015
(86) PCT No.: PCT/CN2015/088018

§ 371 Date: Feb. 26, 2018

(51) Int. Cl. G01N 15/06

(52) U.S. Cl. CPC G01N 15/06; G01N 2015/0693

(57) ABSTRACT

Systems, methods, and devices for sensing dust are described herein. One system includes a controller (450) for utilizing a dust sensor (456) comprising a memory (454) and a processor (452) configured to execute executable instructions stored in the memory (454) to sample a plurality of low pulse occupancies of a particle measurement system at a predetermined interval, wherein the plurality of low pulse occupancies produce a number of spikes. The controller (450) can reduce the number of spikes by applying a recursive moving average to the plurality of low pulse occupancies. The controller (450) can display, on a user interface, an air level condition based on the plurality of low pulse occupancies and the recursive moving average.

### TECHNICAL FIELD

The present disclosure relates to systems, methods, and devices for utilizing a dust sensor indicator.

### BACKGROUND

A dust sensor can be used in indoor air indicators, air cleaners, and air filters, among other air devices. Dust sensors can be based on light-scattering principles. However, the optics, electronics, mechanics, and/or air flow introduction associated with the light-scattering principles, can have a wide deviation range even after calibration. Additionally, and/or alternatively, the calibration for such air indicators, may be performed using two measurement points, which may not improve accuracy.

Further, the maintenance of such a system is problematic as the readings may not be meaningful to a user and/or to the functioning of the dust sensor. The calibration deviations and/or the lack of meaningful readings and/or inaccurate readings may cause the indoor air indicator to be unreliable, and therefore may not be relied upon by a user and/or the functioning of the dust sensor for air indications.

### BRIEF DESCRIPTION OF THE DRAWINGS

FIG. 1 illustrates a graph for utilizing a dust sensor indicator, in accordance with one or more embodiments of the present disclosure.

FIG. 2 illustrates a method for utilizing a dust sensor indicator, in accordance with one or more embodiments of the present disclosure.

FIG. 3 is a flow chart of a method for utilizing a dust sensor indicator, in accordance with one or more embodiments of the present disclosure.

FIG. 4 is a system schematic block diagram of a controller for utilizing a dust sensor indicator, in accordance with one or more embodiments of the present disclosure.

### DETAILED DESCRIPTION

Systems, methods, and devices for utilizing a dust sensor indicator are described herein. For example, one or more embodiments includes a controller for utilizing a dust sensor indicator, comprising a memory and a processor configured to execute executable instructions stored in the memory to sample a plurality of low pulse occupancies of a dust (e.g. particle) measurement system at a predetermined interval, wherein the plurality of low pulse occupancies produce a number of spikes, reduce the number of spikes by applying a recursive moving average to the plurality of low pulse occupancies, and display, on a user interface, an air level condition based on the plurality of low pulse occupancies and the recursive moving average.

Particulate matter is a particle pollution that can be a mixture of solids and/or liquid droplets in the air. Some particles can be released directly from a specific source, while others form via complex chemical reactions in the atmosphere. The particle matter can come in a variety of range sizes, including coarse dust particles and/or fine particles. For example, particles less than or equal to 10 micrometers in diameter are small particles which can enter the lungs, potentially causing serious health problems. Particles less than 2.5 micrometers in diameter (PM_{2.5}) may be classified as “fine” particles and may pose the greatest health risks.

That is, the smaller the particle matter, the increased possibility of the particle matter entering the lungs and causing potential health problems. In other words, fine particles may lodge deeply into the lungs that are vulnerable to injury and cause health problems.

A dust sensor indicator, in accordance with the present disclosure, can allow for improved accuracy and/or performance for detecting fine particulate matter (e.g., PM_{2.5}) while providing a digital display of meaningful air quality and/or air pollution levels. The improved accuracy and/or performance for detecting fine particulate matter can be achieved, in some embodiments, by embedding a combination of algorithms into a piece of acquisition hardware connected with a chosen dust sensor. In other words, the dust sensor indicator can be integrated into air cleaners and/or be an individual indicator product.

The digital display can include, in some embodiments, a reading of mass concentration using a particle matter 2.5 (PM_{2.5}) reading. That is, the air quality and/or air pollution can be calculated as a mass concentration of the fine particles.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

The figures herein follow a numbering convention in which the first digit or digits correspond to the drawing figure number and the remaining digits identify an element or component in the drawing.

As used herein, “a” or “a number of” something can refer to one or more such things. For example, “a number of spikes” can refer to one or more spikes.

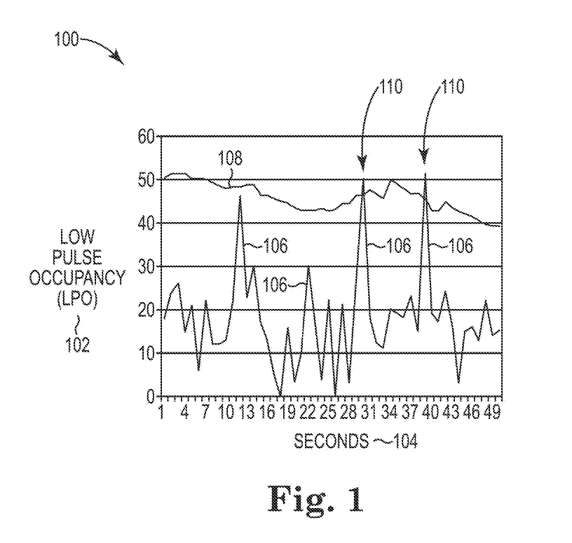

FIG. 1 illustrates a graph for utilizing a dust sensor indicator, in accordance with one or more embodiments of the present disclosure. The graph 100 can include variables of seconds 104 and a low pulse occupancy (LPO) 102 unit. A unit can include a unit low pulse time, as depicted on the vertical axis of FIG. 1 (e.g., 102). The unit, as used herein, can mean the duration of low pulses (e.g., low voltages) in every second.

The summation of all units of a predetermined time can be a LPO. A LPO can be proportional to mass concentration. In some embodiments, a LPO can be a summation of a series of LPO units over the predetermined time. For example, the predetermined time can be 30 seconds, divided into 1 second increments, which can total 30 time “steps.” In this example, the LPO would be the summation of the units (e.g., 30) over the predetermined time (e.g., 30 seconds), totaling 1 step at each 1 second.

To measure a LPO for different particle sizes, the dust sensor can provide a variable input which allows adjustment to a pass-band filter within. As shown in FIG. 1, the graph 100 can include sample data 106 and a mass concentration of particulate matter with a diameter of 2.5 or less (PM_{2.5}) 108.

A controller (not shown) can sample a plurality of low pulse occupancies of a dust (e.g. particle) measurement system at a predetermined interval (e.g., time in seconds 104). LPOs can measure a particulate matter level in the air by counting the low pulse occupancy time in a given time unit. That is, the LPO percentage (e.g., mass/concentration) is in proportion to a particulate matter concentration. The plurality of low pulse occupancies produce a number of spikes 110.

As illustrated in FIG. 1, the plurality of low pulse occupancies 102 can be sampled by the controller at a two second time interval 104. The LPOs can be sampled every two seconds for a time interval of 30 seconds. In other words, within a 30 second time interval, the LPOs can be sampled 15 times.

A low pulse occupancy (LPO) can be the summation of low pulse durations over a particular observation period (e.g., 30 seconds, 60 seconds, etc.). For example, if 600 ms of total low voltage levels were measured over a 30 second sampling time, the LPO may be 600/30000, which equals 0.02%, or 2%. If within the sampling time of 30 seconds, and a particular long duration of low voltages had been observed, such as 100 ms, 150 ms, then these would be considered “spikes” because it took more time. The increased time, (e.g., spikes) may be caused by a large particle passing through the particle system.

In some embodiments, a spike 110 that is greater than a threshold value range may be observed. A spike can be a moving particles detected by a photodiode due to large particles pass through the detection area and/or turbulent air flow carrying an abnormal large number of particles through the detection area. A spike can be a LPO in a second unit of time. A spike 110 can indicate the time (e.g., time span, time frame, duration, etc.) before the reading can be displayed to a user. In other words, a spike 110 can be the time to convert the readings to a concentration. In some examples, a spike 110, as a portion of a LPO, can cause a significantly higher (e.g., increased) concentration (e.g., concentration reading) compared to a plurality of different LPO readings.

The controller associated with the dust sensor indicator can, in some embodiments, reduce the number of spikes 110 by applying a recursive moving average to the plurality of low pulse occupancies. A recursive moving average can be applied to enhance the effect of smoothing data. For example, a recursive moving average can calculate an average from a plurality of LPO readings.

For instance, the moving interval can be calculated using the number of LPO readings divided by the observation time to produce the raw data set. The moving average, by this use, can stabilize the data set each time there is an update.

In some embodiments, the controller can calculate the recursive moving average based on the predetermined interval. For example, the predetermined interval (e.g., measuring time period) for each LPO may be a 30 second interval. The sampling interval can be every two seconds. The moving average can be based on an array of previously calculated LPOs. For instance, the array length can be 30 LPOs.

In some embodiments, a spike among the number of spikes 110 can be reduced within a threshold range within a predetermined interval. The number of spikes 110 can be limited to a predefined threshold (e.g., limited, reduced in number of occurrences). For example, for a predetermined interval (e.g., time) of 100 seconds, sampled every 2 seconds (unit time), then a 150 m/s low pulse duration can be limited to 100. Spikes can be limited based on the predefined threshold. For instance, only two spikes 110 (e.g., LPOs outside of a threshold range) above 50 can be permitted.

As an example of a recursive moving average, a series of eight (8) low pulse occupancies can be observed within a predetermined interval (e.g., time). The average of the eight low pulse occupancies can be calculated. Over the threshold interval, as additional low pulse occupancies are observed, the average can be updated. The controller can use the latest (e.g., most recent) low pulse occupancy reading or the previously calculated average based on whether the latest low pulse occupancy is within or outside of a threshold range.

The recursive moving average can include a threshold value range. Additionally, or alternatively, the threshold value range can determine a particular low pulse occupancy sample to use to calculate a mass concentration, in some embodiments. For example, the recursive moving average can calculate an average LPO (e.g., LPO value) over a number of recently calculated LPOs. The threshold can be used to check whether the current (e.g., the latest, most recent) LPO deviates from the newly calculated average LPO. If the subtraction of the current LPO and the LPO minus the recursive average (e.g., LPO-Average), then the latest LPO reading can be used in the calculation. The latest LPO reading, as used herein, is the most recent LPO reading.

Additionally, or alternatively, if the latest LPO reading is outside of a threshold (e.g., above or below x or y), then a different reading may be used. That is, if the latest LPO reading is above the threshold (e.g., above y), the lower (e.g., smaller) LPO of the latest LPO and the previous (e.g., last) LPO recursive moving average can be used to calculate the mass concentration (e.g., PM_{2.5}). Alternatively, if the latest LPO is below the threshold (e.g., below x), then the higher (e.g., larger) LPO reading and the previous (e.g. last) LPO average can be used to calculate the mass concentration (e.g., PM_{2.5}).

The controller, in some embodiments, can display, on a user interface, an air level condition based on the plurality of low pulse occupancies (LPO) and the recursive moving average. The air level condition can be displayed as a mass concentration reading and/or a generic reading indicating “superior,” “good,” “average,” “poor,” or “bad” air quality. In some embodiments, the readings can be depicted as a color code, a numerical code, and/or symbols, or a combination thereof, to depict the air quality.

In some embodiments, the controller can include a user interface display to depict a concentration of air pollutants. In some embodiments, the display can depict to a user a particular number using micrograms per meter cubed. The air level condition, in some embodiments, can reflect a particle matter less than 2.5 micrometers (PM_{2.5}) (e.g., fine particles) mass concentration of air pollutants. That is, the air level condition can identify the amount of fine and/or dangerous amounts of fine particle matters in the air. In some embodiments, the air level condition can be displayed in microgram per meter cubic (mass/concentration) units. One benefit of using the microgram per meter cubic units is that the system can provide a user with a more accurate reading of the air quality level, as opposed to a general “good” or “bad” reading.

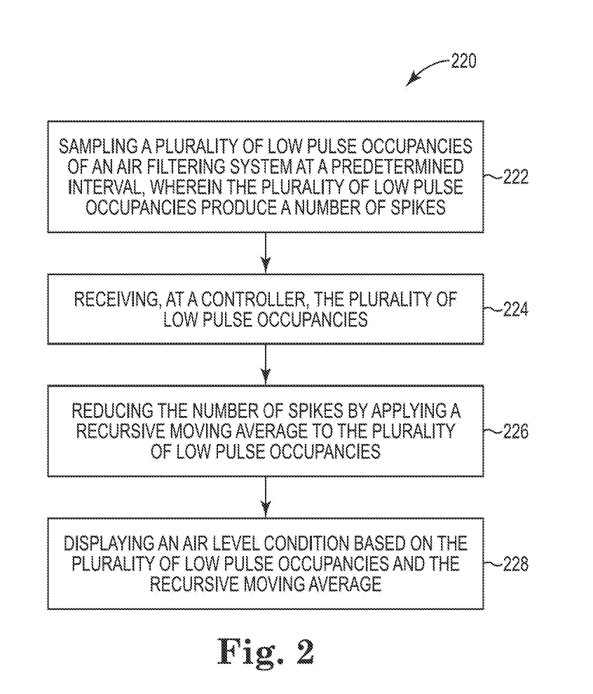

FIG. 2 illustrates a method for utilizing a dust sensor, in accordance with one or more embodiments of the present disclosure.

At block 222, the method 220 for utilizing a dust sensor indicator can include sampling, using a controller, a plurality of low pulse occupancies of an dust (e.g. particle) measurement system at a predetermined interval, where the plurality of low pulse occupancies produce a number of spikes.

At block 224, the method 220 can include receiving, at a controller, the plurality of low pulse occupancies. For example, in some embodiments, the controller can receive the plurality of low pulse occupancies and convert the raw data into a mass concentration unit by applying a moving average, as described in connection to FIG. 1.

At block 226, the method 220 can include reducing the number of spikes by applying a recursive moving average to the plurality of low pulse occupancies. In some embodiments, reducing the number of spikes in the method 220 can limit spikes within a threshold range within the predetermined interval.

In some embodiments, limiting the spikes can include stabilizing a mass concentration reading. That is, limiting the spikes can, in some instances, prevent outlier data and/or a single inaccurate reading from being relied upon, which can negatively impact the overall concentration reading. In other words, limiting spikes, as previously discussed in connection with FIG. 1, can increase accuracy and/or performance of the dust sensor indicator.

At block 228, the method 220 can include displaying an air level condition based on the plurality of low pulse occupancies and the recursive moving average. In some embodiments, the air level condition can be displayed on a user interface associated with the controller.

For instance, the air level condition can be displayed on a screen with a graphical user interface (GUI). The air level condition can be displayed as a mass concentration unit, and/or a generic air quality reading (e.g., good, bad, etc.).

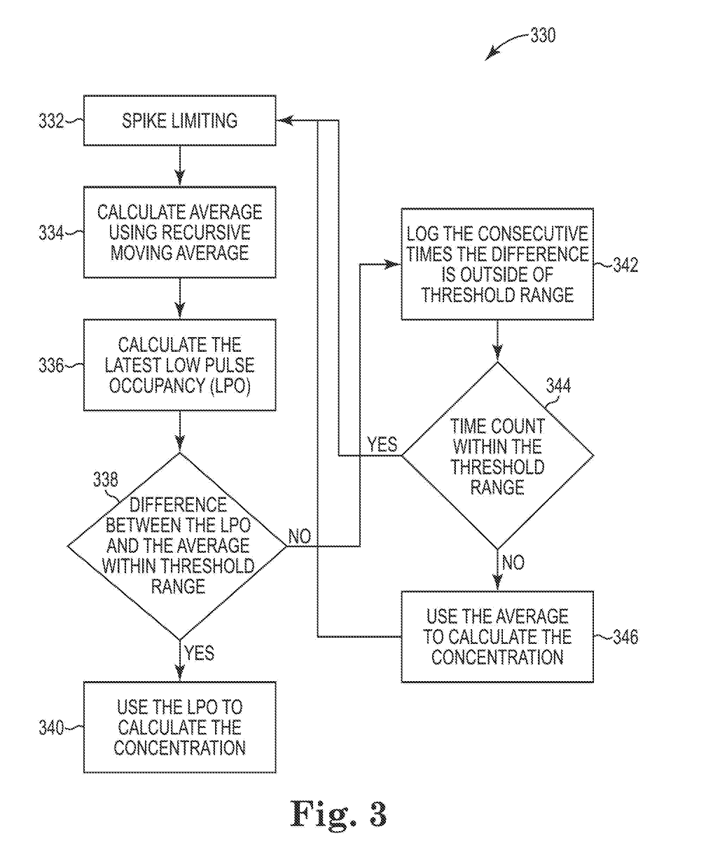

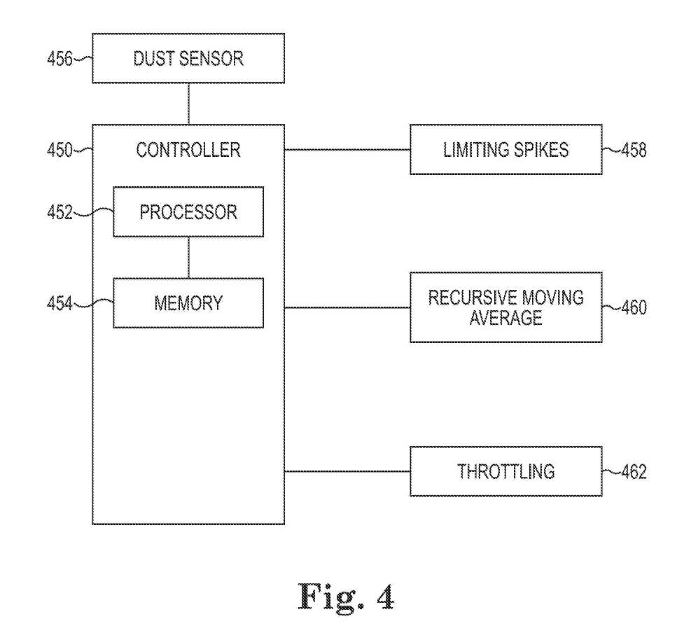

FIG. 3 is a flow chart 330 of a method for utilizing a dust sensor indicator, in accordance with one or more embodiments of the present disclosure. Analogous to FIGS. 1 and 2, a system for utilizing a dust sensor indicator can include a number of sensors to sample a plurality of low pulse occupancies of a dust (e.g. particle) measurement system. A controller, as described further herein in relation to FIG. 4, can receive the sampled plurality of low pulse occupancies, as previously discussed herein.

At block 332 of the flow chart 330, a controller can limit the number of spikes among a plurality of low pulse occupancies. In some examples, the spikes can be limited to a particular number exceeding a particular threshold within a threshold interval. For example, spikes can be limited to two spikes above a threshold of 50 low pulse occupancies in a predetermined interval (e.g., time) of 30 seconds and a sampling interval of two seconds.

At block 334, the controller can calculate an average using a recursive moving average. For example, the controller can apply a moving average to the plurality of low pulse occupancies to reduce a number of spikes associated with the low pulse occupancies.

At block 336, the controller can calculate the latest low pulse occupancy. The latest low pulse occupancy can be, as previously discussed, the most recent low pulse occupancy. For example, three low pulse occupancies are observed. The latest low pulse occupancy can be the third observer low pulse occupancy because it is the latest (e.g., most recent, newest, etc.).

At block 338, a difference of the low pulse occupancy and the average within a threshold range can be determined. If the low pulse occupancy is within the threshold range, then at block 340 the controller can use the latest (e.g., most recent) low pulse occupancy to calculate the mass concentration. That is, the low pulse occupancy reading falls within the x and y threshold range.

Alternatively, if the average is not within a threshold range at block 338, then at block 342, the controller can log the consecutive times the differences is outside of the threshold range. The number of times the differences are outside of the threshold range can, in some instances, be a spike. That is, the low pulse occupancies can be above a threshold range. For instance, 110 in FIG. 1 is a spike.

At block 344, a time count within the threshold range can be determined. If the time count is within the threshold range (e.g., yes), the flow chart can be iterative and repeat.

Alternatively, if the time count is not within the threshold range, at block 346 the controller can use the average to calculate the mass concentration. The count threshold can assist in identifying rapidly ascending and/or descending trends of concentration changes (e.g., PM_{2.5}). For example, if a consecutive count of positive values of the current LPO minus the average LPO (e.g., LPO−average LPO), and the count number exceeds the predefined count threshold, then the concentration can be identified as increasing (e.g., exceeding, higher, etc.). In this instance, the current LPO (e.g., most recent, latest LPO reading) can be used as the final result. That is, when the count number exceeds the predefined threshold, then the current LPO can be relied upon. Alternatively, if the time count is not within the threshold range (e.g., the time count is above or below the threshold range), then at block 346 the controller can use the LPO average to calculate the mass concentration.

In some embodiments, the controller can display, on a user interface, an air level condition based on a calculation associated with the low pulse occupancies. For example, the air level condition can be displayed using micrograms per meter cubic as a unit and/or a visual indication. In some instances, the visual indication can include colors and/or labels (e.g., good, bad, etc.). The air level condition can alert a user as to the air quality and/or a level of danger posed by fine particulate matter in the air.

FIG. 4 is a system schematic block diagram of a controller 450 for utilizing a dust sensor, in accordance with one or more embodiments of the present disclosure. Controller 450 can be, for example, controller(s) previously described in connection with FIGS. 1, 2, and 3, respectively.

The controller 450 can include a memory 454. The memory 454 can be any type of storage medium that can be accessed by a processor 452 to perform various examples of the present disclosure. For example, the memory 454 can be a non-transitory computer readable medium having computer readable instructions (e.g., computer program instructions) stored thereon that are executable by the processor 452 to receive, from a dust sensor 456, a plurality of low pulse occupancies of a dust (e.g. particle) measurement system.

Additionally, the processor 452 can execute instructions to limit spikes 458 (e.g., reducing the number of spikes within a given time interval) within a threshold range within a predetermined interval. Additionally, processor 452 can execute the executable instructions stored in memory 454 to apply a recursive moving average 460 to the plurality of low pulse occupancies to reduce a number of spikes associated with the low pulse occupancies. Further, processor 452 can execute the executable instructions stored in memory 454 to throttle data to calculate the recursive moving average and/or determine a mass concentration. Moreover, processor 452 can execute executable instructions stored in memory 454 to display the mass concentration of air quality on a user interface on a controller.

In some embodiments, the controller may not modify a chosen dust sensor and can be attached to the chosen dust sensor. That is, the dust sensor indicator can be attached to an existing dust sensor.

The memory 454 can be volatile or nonvolatile memory. The memory 454 can also be removable (e.g., portable) memory, or non-removable (e.g., internal) memory. For example, the memory 454 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 454 is illustrated as being located within controller 450, embodiments of the present disclosure are not so limited. For example, memory 454 can also be located internal to another computing resource (e.g., enabling computer readable instructions to be downloaded over the Internet or another wired or wireless connection).

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A controller for utilizing a dust sensor indicator, comprising;
a memory; and
a processor configured to execute executable instructions stored in the memory to:
sample a plurality of low pulse occupancies of a particle measurement system at a predetermined interval, wherein the plurality of low pulse occupancies produce a number of spikes;
reduce the number of spikes by applying a recursive moving average to the plurality of low pulse occupancies; and
display, on a user interface, an air level condition based on the plurality of low pulse occupancies and the recursive moving average.

2. The controller of claim 1, further comprising instructions to calculate the recursive moving average based on the predetermined interval.

3. The controller of claim 1, wherein the recursive moving average includes a threshold value range.

4. The controller of claim 3, wherein the threshold value range determines a particular low pulse occupancy sample to use to calculate a mass concentration.

5. The controller of claim 1, wherein the air level condition reflects a PM2.5 mass concentration of air pollutants.

6. The controller of claim 1, wherein the controller includes a user interface display to depict a concentration of air pollutants.

7. The controller of claim 1, wherein instructions to reduce the number of spikes reduces spiking within a threshold range within the predetermined interval.

8. The controller of claim 1, further comprising instructions to display the air level condition in microgram per meter cubic (mass/concentration) units.

9. A method for utilizing a dust sensor indicator, comprising:
sampling, using a controller, a plurality of low pulse occupancies of a particle measurement system at a predetermined interval, wherein the plurality of low pulse occupancies produce a number of spikes;
receiving, at a controller, the plurality of low pulse occupancies;
reducing the number of spikes by applying a recursive moving average to the plurality of low pulse occupancies; and
displaying an air level condition based on the plurality of low pulse occupancies and the recursive moving average.

10. The method of claim 9, further comprising stabilizing a mass concentration reading.

11. The method of claim 9, wherein the air level condition is displayed on a user interface associated with the controller.

12. The method of claim 9, wherein reducing the number of spikes limits spikes within a threshold range within the predetermined interval.

13. A system for utilizing a dust sensor indicator, including:
a number of sensors to sample a plurality of low pulse occupancies of a particle measurement system;
a controller, configured to:
receive the sampled plurality of low pulse occupancies;
apply a moving average to the plurality of low pulse occupancies to reduce a number of spikes associated with the low pulse occupancies;
display, on a user interface, an air level condition based on a calculation associated with the low pulse occupancies.

14. The system of claim 13, wherein the air level condition is displayed using micrograms per meter cubic and a visual indication, wherein the visual indication includes a colors or labels.

15. The system of claim 13, wherein the controller does not modify a chosen dust sensor and can be attached to the chosen dust sensor.
